(19) United States
(12) Patent Application Publication
(10) Pub. No.: US 2009/0083508 A1
(43) Pub. Date: Mar. 26, 2009

(54) SYSTEM AS WELL AS METHOD FOR MANAGING MEMORY SPACE

(75) Inventors: Clara Maria Otero Perez, Eindhoven (NL); Josephus Van Eijndhoven, Waarle (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,114

(22) PCT Filed: Nov. 4, 2005
(86) PCT No.: PCT/IB2005/053603

§ 371 Date: May 11, 2007

(30) Foreign Application Priority Data
Nov. 11, 2004 (EP) 04105700.1

(51) Int. Cl. G06F 12/02

(52) U.S. Cl. 711/170; 711/E12.005

(57) ABSTRACT

In order to provide a system (100) for managing memory space (22), the system comprising—at least one central processing unit (10) for executing at least one first task (50) and at least one second task (60),—at least one memory unit (20), in particular at least one cache,—being connected with the central processing unit (10) and—comprising the memory space (22) being subdividable into—at least one first memory space (52), in particular at least one first cache space,—and at least one second memory space (62), in particular at least one second cache space, at least one determination means (30) for determining whether the first task (50) and/or the second task (60) requires the memory space (22), and—at least one allocation means (40) for allocating the memory space (22) to the respective task, in particular for allocating—the first memory space (52) to the first task (50) and 15 the second memory space (62) to the second task (60), wherein it is possible to maximize the memory space (22) being provided to each executed task (50, 60), it is proposed that the memory space (22) is allocated to the respective task (50, 60) in dependence on the determined requirement of memory space (22) and according to at least one respective processing budget, which is assigned to each task (50, 60) by at least one processing budget reservation means (12).

The present invention relates to a system according to the preamble of claim 1 as well as to a method according to the preamble of claim 7.

Media processing in software enables consumer terminals to become open and flexible. At the same time, consumer terminals are heavily resource-constrained because of a high pressure on costprice. To be able to compete with dedicated hardware solutions, media processing in software has to use the available resources very cost-effectively, with a high average resource utilization, while preserving typical qualities of consumer terminals, such as robustness, and meeting stringent timing requirements imposed by high-quality digital audio and video processing. An important fact in this respect is the management of memory space.

The efficiency and performance of memory hierarchy, for examples caches, is in particular critical to the performance of multimedia applications running on so-called Systems on Chip (SoCs). Thus, there are many cache scheduling techniques aimed at reducing cache misses or miss delay. Traditional caches have been designed to work well for a single application running on a single processing unit.

For example, prior art documents EP 0 442 474 A2, U.S. Pat. No. 6,427,195 B1 or US 2002/0184445 A1 relate to mechanisms to lock and/or to guarantee cache space to be used by a single task/thread/application (from now on referred as “task”). According to these prior art documents, during the life time of a task the reserved cache space is guaranteed.

In traditional systems, multiple applications execute concurrently sharing the cache. These concurrent applications influence each other's performance by flushing each other's data out of the cache. Moreover, the different types of software structures and memory usage would benefit from different cache organization.

Improving cache efficiency can be done from different angles, for example by
better cache organization: depending on the memory access pattern certain allocation would be more efficient (example: consecutive data elements on different memory banks) or
improved replacement and allocation techniques.

Among the replacement and allocation techniques proposed, some of them use the concept of budgeting (or reservations). A given application/task/thread has exclusive access to a specific part of the cache and will not suffer interference from other applications, which also have their own piece of cache.

In the articles
“Compositional memory systems for multimedia communicating tasks” (by Anca Molnos manuscript Internal Natlab) and
“CQoS: A Framework for Enabling QoS in Shared Caches of CMP Platforms” (by Ravi Iyer, Hillsboro, Oreg., 2004, Proceedings of the 18th annual international conference on Supercomputing, pages 257 to 266, ISBN: 1-58113-839-3),

examples of such budgeting are given which are spatial budgets.

Spatial budgeting improves application performance by improving cache predictability. Furthermore, it enables compositionability of the software subsystem. However, in a resource-constrained system the cache is also a scarce resource; this means that when an application requests a cache budget, this cache space may not be available. In general, applications will not receive as much cache space as required, with the derived performance penalty.

Freeing cache space when a task is not using it is known from prior art document US 2003/0101084 A1. However, this approach can lead to a very low performance if the task will need that data, i.e. memory space.

Starting from the disadvantages and shortcomings as described above and taking the prior art as discussed into account, an object of the present invention is to further develop a system as well as a method of the kind as described in the technical field in such way that the memory space being provided to each executed task is maximized.

The object of the present invention is achieved by allocating the memory space to the respective task
in dependence on the determined requirement of memory space and
according to at least one respective processing budget, which may be assigned to each task by at least one processing budget reservation means.

Advantageous embodiments and expedient improvements of the present invention are disclosed in the respective dependent claims.

The present invention is principally based on the idea of adding time
to memory budgets, in particular to cache budgets, or
to memory reservations, in particular to cache reservations,

and thus provides a temporal cache management technique using budgets.

In other words, the present invention introduces time as a parameter of the memory space reservation, in particular of the cache space reservation. This time is coupled to the processing budget. In this way, the overall memory utilization, in particular the overall cache utilization, is maximized.

Furthermore, when the time parameter of the memory space reservation, for instance of the cache space reservation, is linked to the processing reservation the system performance also improves.

According to a preferred embodiment of the present invention, in a system with a C[entral]P[rocessing]U[nit] resource manager, the first task, for example the first thread or the first application, and/or the second task, for example the second thread or the second application, or the set of tasks/threads/applications receives guaranteed and enforced CPU budgets. Therefore, once this budget is exhausted, the corresponding task(s) will not execute until the budget is replenished again.

This information can be used
to free the memory space, in particular the cache space, used by these tasks and
to make it available for other tasks that do need memory space.

This mechanism leads to a more effective memory space utilization, in particular to a more effective cache space utilization. There is more available memory space for a task having CPU budget and being executed.

Another essential feature of the present invention resides in the fact that the freeing of the memory space occurs when the task for sure will not need it, consequently not resulting in any penalty. Thus, the memory space, in particular the cache budget, which the system can provide to the task or to the application or to the thread, is maximized.

According to a preferred embodiment of the present invention the memory space can be a cache that stores data copies of only a part of the entire system memory. Moreover, according to an advantageous implementation of the present invention the memory space can be a second-level cache that has shared access from multiple C[entral]P[rocessing]U[nit]s.

Such second level cache (or secondary cache or level two cache) is usually
arranged between the first level cache (or primary cache or level one cache) and the main memory and
connected to the C[entral]P[rocessing]U[nit] via at least one external bus.

In contrast thereto, the primary cache is often on the same I[ntegrated]C[ircuit] as the CPU.

The present invention further relates
to a television set comprising at least one system as described above and/or working in accordance with the method as described above as well as
to a set-top box comprising at least one system as described above and/or working in accordance with the method as described above.

According to an advantageous embodiment of the present invention, the method basically comprising the steps of
executing the first task and/or the second task,
determining whether the first task and/or the second task requires memory space,
allocating the memory space to the respective task, in particular allocating
first memory space to the first task and
second memory space to the second task,

additionally may comprise the following steps:
replenishing the processing budget if it is exhausted, wherein the corresponding task is not executed during the replenishing,
determining the time needed for replenishing the respective processing budget, in particular
determining the executing time or busy period of at least one of the tasks and/or
determining the non-executing time of at least one of the tasks, and
allocating the memory space being assigned to a non-executed task to at least one executable task for the determined replenishing time.

Preferably, the memory space is allocated
either exclusively to the first task and/or
partly to the first task and partly to the second task and/or
exclusively to the second task.

In general, the present invention can be used in any product containing caches in which a C[entral]P[rocessing]U[nit] reservation mechanism is present.

In particular, the present invention finally relates to the use of at least one system as described above and/or of the method as described above for any digital system wherein multiple applications are executed concurrently sharing memory space, for example for
multimedia applications, in particular running on at least one S[ystem]o[n]C[hip] and/or
consumer terminals like digital television sets according to claim 5, in particular high-quality video systems, or set-top boxes according to claim 6.

As already discussed above, there are several options to embody as well as to improve the teaching of the present invention in an advantageous manner. To this aim, reference is made to the claims respectively dependent on claim 1 and on claim 7; further improvements, features and advantages of the present invention are explained below in more detail with reference to a preferred embodiment by way of example and to the accompanying drawings where

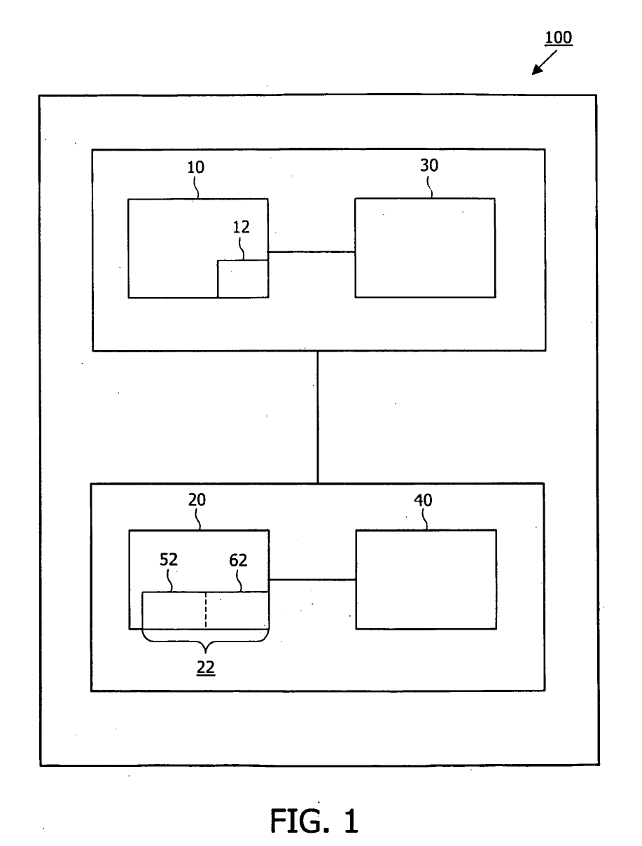

FIG. 1 schematically shows an embodiment of the system according to present invention working according to the method of the present invention;

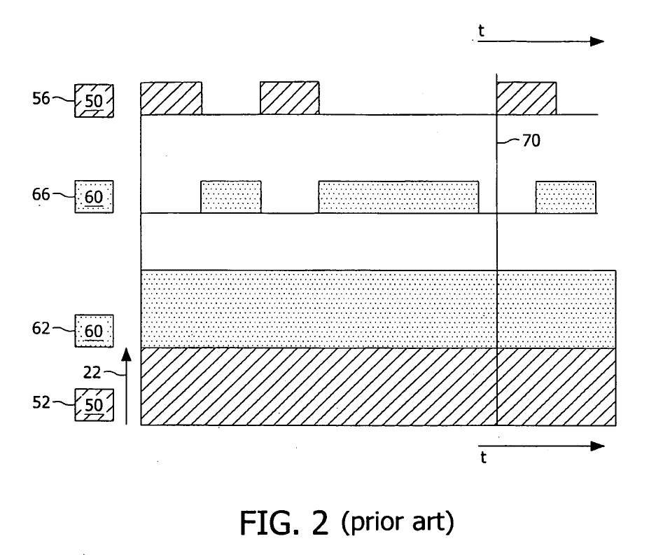

FIG. 2 diagrammatically shows cache management according to the prior art;

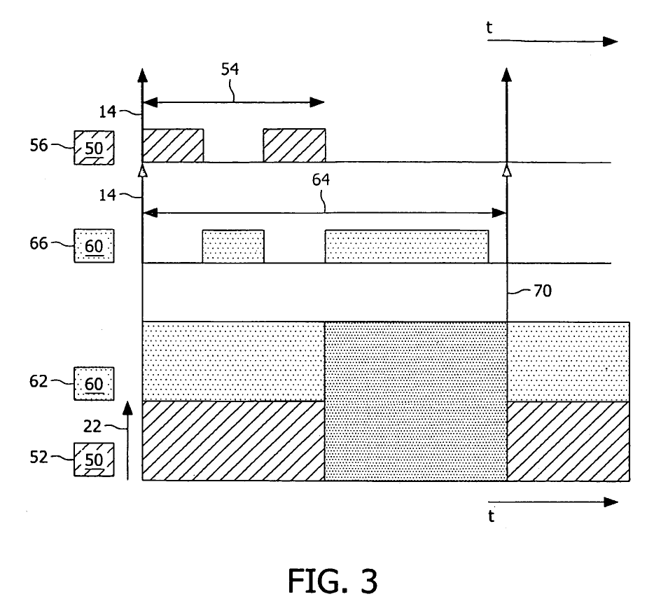

FIG. 3 diagrammatically shows cache management according to the present invention;

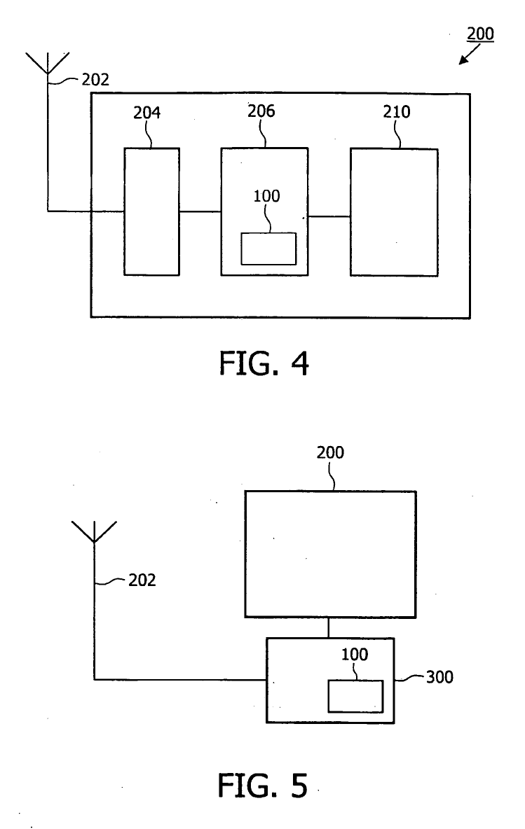

FIG. 4 schematically shows a television set comprising the system of FIG. 1 and being operated according to the cache management of FIG. 3; and

FIG. 5 schematically shows a set-top box comprising the system of FIG. 1 and being operated according to the cache management of FIG. 3.

The same reference numerals are used for corresponding parts in FIG. 1 to FIG. 5.

FIG. 1 illustrates, in a schematic way, the most important parts of an embodiment of the system 100 according to the present invention. This system 100 comprises a central processing unit 10 for executing a first task 50 and a second task 60 (cf. FIG. 3). The central processing unit 10 is connected with a memory unit, namely with a cache 20.

To allocate cache space 22 to the first task 50 and/or to the second task 60, in particular to allocate first cache space 52 to the first task 50 and to allocate second cache space 62 to the second task 60, the system 100 comprises a cache reservation mechanism with an allocation means 40.

In order to assign at least one respective processing budget to each task 50, 60 the system 100 comprises a processing budget reservation means 12, for instance a C[entral]P[rocessing]U[nit] reservation system. The processing budget reservation means 12 can preferably be implemented in the form of at least one software algorithm being executed oil this same CPU 10 or oil one or more other available CPUs in the system 100. For proper operation this software has to rely on some hardware facilities such as at least one timer being capable of interrupting the normal execution of the tasks 50 and 60 on the CPU 10.

Once said processing budget is exhausted, the corresponding task 50, 60 will not be executed until its processing budget is replenished again at the end 70 of a time period. Accordingly, the processing budget of the first task 50 determines the budget busy time 54 of said first task 50 and the processing budget of the second task 60 determines the budget busy time 64 of said second task 60.

The processing budget of the system 100 is available and/or controlled with a granularity much smaller than the life time of the task. For example, a processing budget of five milliseconds repeats each ten milliseconds with respect to the life time of a task of several hours.

The tasks 50, 60 require memory space 22 only during their budget busy time 54, 64. For determining whether the first task 50 and/or the second task 60 requires the memory space 22, the system 100 comprises a determination means 30. The cache space determination means 30 can be implemented as at least one software algorithm.

In order to illustrate the features of the present invention, FIG. 2 illustrates cache management according to the prior art. Task execution 56 over time t of a first task 50 and task execution 66 over time t of a second task 60 is depicted in the upper part of the diagram in FIG. 2.

In the lower part of the diagram in FIG. 2, the cache space 22 is indicated on the vertical axis, and time t runs on the horizontal axis. Thus, cache reservation 52 for the first task 50 and cache reservation 62 for the second task 60 is illustrated in the lower part of the diagram in FIG. 2. As shown in FIG. 2, in prior art systems the first task 50 keeps its cache reservation until the end of a time period 70, even if the first task 50 will not use this cache.

In contrast thereto, cache management according to the present invention is illustrated in FIG. 3. According to FIG. 3, the cache reservation mechanism is used dynamically
by reserving cache space 22 when the first task 50 and/or the second task 60 needs it and
by freeing it when the first task 50 and/or the second task 60 does not need it.

The difference with previous work (cf. FIG. 2) is in the definition of “when the task needs it”. In conventional systems (cf. FIG. 2), the task 50, 60 needs the cache space 22 during its life time. However, according to the present invention (cf. FIG. 3) the need of the cache space 22 is linked to the processing budget availability. To this aim, the cache reservation mechanism or cache reservation system is coupled to the C[entral]P[rocessing]U[nit] reservation system. FIG. 3 depicts an intuitive example:

The first task 50 and the second task 60 execute on the same C[entral]P[rocessing]U[nit] 10 and each of these tasks 50, 60 receives fifty percent of the CPU 10 at the same granularity, for example twenty milliseconds each forty milliseconds. When the first task 50 has finished its budget 54 the space in cache is safely freed and made fully available for the other task 60.

In other words, if the first task 50 has consumed all of its processing budget, then the first cache space 52 being allocated to the first task 50 is freed and is allocated to the second task 62 for the rest of the period. As a result, the task 62 will run more efficiently by using hundred percent of the cache for the rest of the period, i.e. until the budgets are replenished at time 70. Thus, both tasks 50, 60 are able to use hundred percent of the cache 22.

Knowing that a task 50, 60 has finished its budget and will not execute for some time is not easy in the general case. However, if a processing budget is also provided (as proposed by the present invention) then it can be calculated exactly when a task 50, 60 starts executing and when it will finish executing.

According to the present invention, the worst case busy period, i.e. earliest start time and latest end time, can be calculated. Calculating the worst case busy period, the disjoint busy periods can be used to maximize cache budget provision. In FIG. 3, it is illustrated how the cache space 52 used by the first task 50 is freed to be used by the second task 60. The vertical arrows in the upper part of the diagram of FIG. 3 illustrate the budget provision 14.

FIG. 4 illustrates, in a schematic way, the most important parts of a T[ele]V[ision] set 200 that comprises the system 100 as described above. In FIG. 4, an antenna 202 receives a television signal. The antenna 202 may also be, for example, a satellite dish, a cable or any other device able to receive a television signal. A receiver 204 receives the signal. Besides the receiver 204, the television set 200 comprises a programmable component 206, for example a programmable integrated circuit. This programmable component 206 comprises the system 100. A television screen 210 shows images being received by the receiver 204 and being processed by the programmable component 206, by the system 100 and by other parts normally comprised in a television set, but not shown here for reasons of clarity.

FIG. 5 illustrates, in a schematic way, the most important parts of a set-top box 300 comprising the system 100. The set-top box 300 receives the signal sent by the antenna 202. The television set 200 can show the output signal generated by the set-top box 300 together with the system 100 from a received signal.

The above-described implementation of the present invention potentially enables a multi-tasking system wherein the cache space is made completely free when a new task is switched to so that both or all tasks have hundred percent of the cache. The cache reservation is coupled to the C[entral]P[rocessing]U[nit] reservation system.

The above-described method manages cache space 20 being shared between multiple tasks 50, 60. This method is equally applicable for a system 100 containing multiple CPUs 10. In such multi-CPU system 100, there is typically a shared cache as part of the memory hierarchy being manageable for task sharing with identical advantages.

### LIST OF REFERENCE NUMERALS

100 system for managing memory space

10 central processing unit, in particular multiple central processing unit

12 processing budget reservation means, in particular central processing unit reservation means

14 budget provision

20 memory unit, in particular cache unit

22 memory space, in particular cache space

30 determination means

40 allocation means

50 first task

52 first memory space, in particular allocated to the first task 50

54 executing time or busy period or budget busy time of the first task 50

56 task execution of the first task 50

60 second task

62 second memory space, in particular allocated to the second task 60

64 executing time or busy period or budget busy time of the second task 60

66 task execution of the second task 60

70 end of time period, in particular end of replenishing time

200 television set

202 antenna

204 receiver

206 programmable component, for example programmable I[ntegrated]C[ircuit]

210 television screen

300 set-top box

t time or time period

1. A system (100) for managing memory space (22), the system comprising
at least one central processing unit (10) for executing at least one first task (50) and at least one second task (60),
at least one memory unit (20),
being connected with the central processing unit (10) and
comprising the memory space (22) being subdividable into
at least one first memory space (52), and
at least one second memory space (62),
at least one determination means (30) for determining whether the first task (50) and/or the second task (60) requires the memory space (22), and
at least one allocation means (40) for allocating
the first memory space (52) to the first task (50) and
the second memory space (62) to the second task (60),
characterized in
that the memory space (22) is allocated to the respective task (50, 60)
in dependence on the determined requirement of memory space (22) and
according to at least one respective processing budget, which is assigned to each task (50, 60) by at least one processing budget reservation means (12).

2. The system according to claim 1, wherein
once said processing budget is exhausted, the corresponding task (50, 60) is not executed until an end (70) of a processing budget period, and
the determination means (30) is operable
for determining an executing time or busy period of at least one of the tasks and/or
for determining a non-executing time of at least one of the tasks (50, 60), and
the allocation means (40) is operable for allocating the memory space (22) being assigned to a non-executed task to at least one executable task (50, 60).

3. The system according to claim 1, wherein a lifetime of the task (50, 60) is longer than a granularity of its respective processing budget.

4. The system according to claim 1, characterized in that the memory space (22)
is allocated
either exclusively to the first task (50) or
partly to the first task (50) and partly to the second task (60) or
exclusively to the second task (60) and
is a cache designed to store data copies of at least part of the entire system memory or
is a second-level cache having shared access from multiple central processing units (10).

5. A television set (200) comprising a system according to claim 1.

6. A set-top box (300) comprising a system according to claim 1.

7. A method for managing memory space (22), and in particular for scheduling at least one first task (50) and at least one second task (60), the method comprising the steps of:
executing the first task (50) and/or the second task (60),
determining whether the first task (50) and/or the second task (60) requires memory space (22),
allocating
first memory space (52), to the first task and
second memory space (62) to the second task,
characterized in
that the memory space (22) is allocated to the respective task (50, 60)
in dependence on the determined requirement of memory space (22) and
according to at least one respective processing budget being assigned to each task (50, 60).

8. The method according to claim 7, characterized by the additional steps of:
replenishing the processing budget if it is exhausted, wherein the corresponding task (50, 60) is not executed until an end (70) of a processing budget period,
determining
the executing time or busy period (54, 64) of at least one of the tasks (50, 60) and/or
the non-executing time of at least one of the tasks (50, 60), and
allocating the memory space (22) being assigned to a non-executed task to at least one executable task (50, 60), in particular until the end (70) of the determined processing budget period.

9. The method according to claim 7, characterized in that the memory space (22) is allocated
either exclusively to the first task (50) or
partly to the first task (50) and partly to the second task (60) or
exclusively to the second task (60).

10. A system (100) according to claim 1 wherein multiple applications execute concurrently sharing memory space (22) for
multimedia applications, in particular running on at least one S[ystem]o[n]C[hip] or
consumer terminals.
